(19) United States
(12) Patent Application Publication
(10) Pub. No.: US 2011/0091720 A1
(43) Pub. Date: Apr. 21, 2011

(54) Boride nanoparticle-containing fiber and textile product that uses the same

(75) Inventors: Kayo Yabuki, Ichikawa-shi (JP); Kenichi Fujita, Ichikawa-shi (JP); Hiromitsu Takeda, Ichikawa-shi (JP); Kenji Adachi, Ichikawa-shi (JP)

(73) Assignee: SUMITOMO METAL MINING CO., LTD., Tokyo (JP)

(21) Appl. No.: 12/926,924

(22) Filed: Dec. 17, 2010

Related U.S. Application Data
(63) Continuation of application No. 11/631,162, filed on Feb. 16, 2007.

(51) Int. Cl. B32B 5/02; D02G 3/00

(52) U.S. Cl. 428/328; 428/221; 977/773

(57) ABSTRACT

An object is to provide a fiber that absorbs heat with good efficiency, has excellent transparency and heat-retaining properties, and does not compromise the design characteristics of a textile product, and to provide a textile product in which the fiber is used. Hexaboride nanoparticles, a dispersion medium, and a dispersion agent for dispersing the nanoparticles are mixed together. The mixture is dispersed and dried to obtain a dispersion powder. The resulting dispersion powder is added to thermoplastic resin pellets, uniformly mixed, and thereafter melted and kneaded to obtain a master batch containing a heat-absorbing component. The master batch containing a heat-absorbing component is mixed with a similarly prepared master batch to which inorganic nanoparticles has not been added, and the mixture is melted, spun, and drawn to manufacture a multifilament yarn. The multifilament yarn is cut to fabricate staples, and the staples are used to manufacture a spun yarn having heat-absorbing effects. The spun yarn is used to obtain a knitted product having heat-retaining properties.

This is a Continuation of application Ser. No. 11/631,162 filed Feb. 16, 2007, which is a National Phase of PCT/JP2004/010120 filed Jul. 15, 2004. The disclosure of the prior applications is hereby incorporated by reference herein in its entirety.

### TECHNICAL FIELD

The present invention relates to a fiber that contains a heat-absorbing component and to a textile product obtained by processing the fiber.

### BACKGROUND ART

In the textile field, there is a need for fibers that have a variety of special functions. One such fiber is a fiber endowed with heat-retaining properties. Common methods for increasing the heat-retaining properties of a textile product include increasing the thickness of the cloth, reducing the mesh size, and darkening the color.

Patent Document 1 describes a technique whereby the heat-retaining properties of a fiber are improved by using a heat-radiating fiber that contains inorganic nanoparticles having heat-radiating characteristics in which at least one type of metal or metal ion having a thermal conductivity of 0.3 kcal/m2 sec° C. or higher is added to one or more types of inorganic nanoparticles such as silica or barium sulfate.

Patent Document 2 describes a technique in which, 0.1 to 20 wt %, as calculated relative to the weight of the fiber, of ceramic nanoparticles having far-infrared radiation ability are added to the fiber to endow [the fiber] with excellent heat-retaining properties. Described in the document is a method in which aluminum oxide particles and particles having light-absorbing and heat-transforming ability are added as the ceramic nanoparticles to provide heat-retaining properties.

Patent Document 3 proposes an infrared-absorbing processed textile product in which an infrared absorbent comprising an amino compound, and an optionally used binder resin comprising stabilizers and infrared absorbents are dispersed and fixed in place.

Patent Document 4 proposes a method wherein a dye whose absorbency in the near-infrared region is greater than that of a black dye, and which is selected from a direct dye, a reactive dye, a naphthol dye, and a vat dye, is combined with other dyes to dye a fiber, whereby a cellulose fiber structure is endowed with near-infrared radiation absorbing properties in which the spectral reflectance of the cloth has a low value of 650 or less in the near-infrared wavelength range of 750 to 1,500 nm.

### [Patent Document 1]

JP-A 11-279830

### [Patent Document 2]

JP-A 5-239716

### [Patent Document 3]

JP-A 8-3870

### [Patent Document 4]

JP-A 9-291463

### DISCLOSURE OF THE INVENTION

### Problems That the Invention is Intended to Solve

The fiber endowed with heat-retaining properties according to conventional techniques, as described above, has a problem in that the required amount of additives with respect to the fiber is considerable. Therefore, the specific weight of the fiber is increased, clothing or the like that is manufactured from this fiber is made heavier, and uniform dispersion of additives in the melted spun yarn is made difficult.

There is also a problem in that the infrared absorbent that is used is preferably an organic dye, a black dye, or the like when an organic material or a dye is used. Therefore, degradation due to heat and humidity is dramatic and weather resistance is inferior. There is a further problem in that because a dark color is used for coloring in order to add these materials to a fiber, the inventions cannot be used in light-colored products, and the range of fields in which the inventions can be used is limited.

In addition to the methods described above, a method is also known in which aluminum, titanium, or another metal powder is anchored or deposited by vapor deposition or another method onto the fiber, whereby a radiation reflection effect is imparted and heat-retaining properties are improved. However, applications for this method are limited because there are problems in that the color of the fiber is changed by the anchoring or deposition process, costs are increased by vapor deposition, deposition defects occur due to small variations in the way the cloth is handled during preparatory steps to vapor deposition, the heat-retaining capacity is reduced due to fallout of vapor deposited metals caused by friction during washing or wearing, and various other problems occur.

The present invention was contrived in view of the background described above, and an object is to provide a fiber that has excellent transparency and weather resistance and that and contains a heat-absorbing component that absorbs heat with good efficiency, and to provide a textile product that uses the fiber, and does not compromise designability while having excellent heat-retaining properties.

### Means of Solving the Problems

As a result of thoroughgoing research to solve the above-described problems, the present inventors discovered that boride nanoparticles expressed by the general formula XBₘ (wherein X is at least one or more elements selected from La, Ce, Pr, Nd, Sm, Eu, Gd, Tb, Dy, Ho, Er, Tm, Yb, Lu, Sr, Ca, and Y) can be used as a heat-absorbing component capable of solving the above-described problems. The present inventors discovered that boride nanoparticles have large amounts of free electrons, and by forming such nanoparticles makes it possible to endow the material itself with very low transmissivity in the visible region, and strong absorbency, and hence very low transmissivity, in the near infrared region. The present invention was perfected through the discovery that a fiber can be endowed with heat-retaining properties by incorporating the boride nanoparticles into the surface and/or interior of a fiber to cause the fiber to manifest strong absorbency in the near infrared region.

Specifically, in order to solve the aforementioned problems, a first aspect of the present invention provides a boride nanoparticle-containing fiber comprising boride nanoparticles expressed by the general formula XBₘ (wherein X is at least one or more elements selected from La, Ce, Pr, Nd, Sm, Eu, Gd, Tb, Dy, Ho, Er, Tm, Yb, Lu, Sr, Ca, and Y) as a heat-absorbing component, wherein the surface and/or the interior of the fiber contains 0.001 wt % to 30 wt % of the nanoparticles with respect to the solid content of the fiber.

A second aspect of the present invention provides the boride nanoparticle-containing fiber according to the first aspect, further comprising a far-infrared emissive material, wherein the surface and/or the interior of the fiber contains 0.001 wt % to 30 wt % of the far-infrared emissive material with respect to the solid content of the fiber.

A third aspect of the present invention provides the boride nanoparticle-containing fiber according to the second aspect, wherein the far-infrared emissive material is ZrO₂ nanoparticles.

A fourth aspect of the present invention provides the boride nanoparticle-containing fiber according to any of the first to third aspects, wherein the particle diameter of the boride nanoparticles is 800 nm or less.

A fifth aspect of the present invention provides the boride nanoparticle-containing fiber according to any of the first to fourth aspects, wherein the surface of the boride nanoparticles is covered with a compound containing at least one or more elements selected from silicon, zirconium, titanium, and aluminum.

A sixth aspect of the present invention provides the boride nanoparticle-containing fiber according to the fifth aspect, wherein the compound is an oxide.

A seventh aspect of the present invention provides the boride nanoparticle-containing fiber according to any of the first to sixth aspects, wherein the fiber is a synthetic fiber, a semisynthetic fiber, a natural fiber, a recycled fiber, an inorganic fiber, or a yarn mixture composed of a blend, a doubled yarn, a combined filament yarn, or another combination of the fibers.

An eighth aspect of the present invention provides the boride nanoparticle-containing fiber according to the seventh aspect, wherein the synthetic fiber is a synthetic fiber composed of one or more fibers selected from polyurethane fiber, polyamide fiber, acrylic fiber, polyester fiber, polyolefin fiber, polyvinyl alcohol fiber, polyvinylidene chloride fiber, polyvinyl chloride fiber, and polyether-ester fiber.

A ninth aspect of the present invention provides the boride nanoparticle-containing fiber according to the seventh aspect, wherein the semisynthetic fiber is a semisynthetic fiber composed of one or more fibers selected from cellulose fiber, protein fiber, chlorinated rubber, and hydrochlorinated rubber.

A tenth aspect of the present invention provides the boride nanoparticle-containing fiber according to the seventh aspect, wherein the natural fiber is a natural fiber composed of one or more fibers selected from plant fiber, animal fiber, and mineral fiber.

An eleventh aspect of the present invention provides the boride nanoparticle-containing fiber according to the seventh aspect, wherein the recycled fiber is a recycled fiber composed of one or more fibers selected from cellulose fiber, protein fiber, algin fiber, rubber fiber, chitin fiber, and mannan fiber.

A twelfth aspect of the present invention provides the boride nanoparticle-containing fiber according to the seventh aspect, wherein the inorganic fiber is an inorganic fiber composed of one or more fibers selected from metal fiber, carbon fiber, and silicate fiber.

A thirteenth aspect of the present invention provides a textile product formed by processing the boride nanoparticle-containing fiber according to any of claims 1 to 12.

### BEST MODE FOR CARRYING OUT THE INVENTION

To fabricate a fiber endowed with heat-retaining properties according to the present invention, boride nanoparticles expressed by the general formula XBₘ are added as a heat-absorbing component is fabricated by adding to the surface and/or the interior of a desired fiber. Examples of such nanoparticles include XB₄, XB₆, and XB₁₂.

Described below are boride nanoparticles that are preferred as a heat-absorbing component.

First, the heat-absorbing component is preferably in the range of 4≦m<6.3 in the general formula XBₘ described above. Specifically, the boride nanoparticles are preferably primarily composed XB₄ and XB₆, and may also be partially composed of XB₁₂. As used herein, the variable m refers to the atomic ratio of B per atom of the X element, obtained by chemical analysis of a powder containing the resulting boride nanoparticles.

Ordinarily, a powder containing boride nanoparticles is essentially a mixture of XB₄, XB₆, X₁₂, and the like. Hexaboride is a typical example of boride nanoparticles. In this case, the range is essentially 5.8<m<6.2, even if the nanoparticles are determined to be single-phase particles from the results of X-ray analysis, and it is believed that traces of other phases are included. Here, when m≧4, the generation of XB, XB₂, and the like is reduced, and, although the reason is unknown, the heat-absorbing properties are improved. On the other hand, the generation of boric oxide particles is reduced when m<6.3. Boric oxide particles have moisture-absorbing properties. Therefore, when boric oxide particle contaminate the boride powder, the moisture-proofness of the boride powder is reduced and the degradation of the heat-absorbing properties over time increases. In view of the above, m is preferably kept at less than 6.3 in order to reduce the generation of boric oxide particles.

Described below is an example of hexaboride as the boride material when m=6.

To fabricate the heat-retaining fiber according to the present invention, hexaboride XB₆ (wherein X is one or more elements selected from La, Ce, Pr, Nd, Sm, Eu, Gd, Tb, Dy, Ho, Er, Tm, Yb, Lu, Sr, Ca, and Y) nanoparticles are added as a heat-absorbing component to the surface and/or the interior of fiber.

Examples of the hexaboride used in the present invention include LaB₆, CeB₆, PrB₆, NdB₆, SmB₆, EuB₆, GdB₆, TbB₆, DyB₆, HoB₆, ErB₆, TmB₆, YbB₆, LuB₆, SrB₆, CaB₆, and YB₆.

The hexaboride nanoparticles used in the present invention preferably have unoxidized surfaces, but such particles are often mildly oxidized, and it is impossible to avoid a certain amount of surface oxidation in the process of dispersing the particles. Even in such cases, however, there is no change in the effectiveness with which the sunlight absorption effect is manifest. Also, these nanoparticles manifest a greater sunlight absorption effect as the degree of crystal perfection increases, and even if crystallinity is poor and broad diffraction peaks are generated in X-ray diffraction, a solar radiation absorption effect is manifest as long as the fundamental bonds inside the nanoparticles have a CaB₆ type cubic structure. Additionally, the hexaboride nanoparticles are an inorganic material, and therefore also have excellent weather resistance.

These hexaboride nanoparticles form a powder that is a dark, bluish purple color, a green color, or another color. However, the particle diameter can be made sufficiently small in comparison with the wavelengths of visible light, and although visible light is transmitted in a state in which nanoparticles having such a small grain size are dispersed and added to the surface and/or interior of the fibers, heat-retaining capacity can be kept sufficiently high. This is thought to be due to the fact that hexaboride nanoparticles contain a large amount of free electrons, and the absorption energy of indirect interband transition and plasmon absorption by the free electrons in the surface and interior of the nanoparticles fall in the exact vicinity of visible to near-infrared light. Therefore, heat rays in this wavelength region are selectively reflected and absorbed. It was found by experimentation that transmissivity is very high between the wavelengths of 400 to 700 nm, and very low between the wavelengths of 700 to 1,800 nm in films in which these hexaboride nanoparticles are sufficiently small and uniformly dispersed. In view of this result, wavelength characteristics having the same transmissivity can be obtained even in a fiber in which hexaboride nanoparticles have been added to the surface and/or interior of the fiber.

In this case, considering that the wavelength of light visible to humans is in a range of 380 to 780 nm, and that visibility forms a bell curve that peaks in the vicinity of 550 nm, it is apparent that with a fiber containing such hexaboride nanoparticles, visible light is effectively transmitted and other heat rays are effectively reflected and absorbed.

The heat-absorbing capacity of hexaboride nanoparticles per unit of weight is very high, and the effects can be demonstrated using 1/40 to 1/100 or less of the amount that used in the case of ITO and ATO. Therefore, there is an advantage in that the physical properties of the fiber are not compromised because sufficient heat-absorbing capacity can be assured even when the amount of nanoparticles added to a desired fiber is low. It is naturally possible to add a considerable amount [of nanoparticles] as desired, and the amount of hexaboride nanoparticles that is added to the surface and/or interior of the fibers can be selected from a range of 0.001 wt % to 30 wt % with respect to the solid content of the fiber. Also, from the standpoint of materials cost and the weight of fiber after the hexaboride nanoparticles have been added, the range is preferably in a range of 0.005 wt % to 15 wt %, and more preferably in a range of 0.005 wt % to 10 wt %. If the added amount is 0.001 wt % or higher, sufficient heat-absorbing capacity can be obtained even if the cloth is thick. If the added amount is less than 30 wt %, a reduction in the spinnability due to filter clogging, yarn breakage, and other problems can be avoided in the spinning step. If the added amount is 15 wt % or less, spinnability can be further stabilized, and the added amount is more preferably 10 wt % or less.

Another preferred configuration is one in which the nanoparticles of a material having infrared emission capacity are added to the surface and/or interior of the fiber together with the hexaboride nanoparticles. Examples of nanoparticles of an infrared emissive material include ZrO₂, SiO₂, TiO₂, Al₂O₃, MnO₂, MgO, Fe₂O₃, CuO, and other metal oxides; ZrC, SiC, TiC, and other carbides; and ZrN, Si₃N₄, AlN, and other nitrides.

The hexaboride nanoparticles have a characteristic whereby light energy of the sun or other light sources having a wavelength of 0.3 to 2 μm is absorbed; particularly, light having a wavelength in the near-infrared region in the vicinity of 1 μm is selectively absorbed and either re-radiated or converted to heat. The nanoparticles of the aforementioned far-infrared radiating material have the ability to receive energy absorbed by the hexaboride nanoparticles, convert [the energy] to heat energy having mid- and far-infrared wavelengths, and radiate the heat energy. ZrO₂ nanoparticles, for example, transform heat absorbed by the hexaboride nanoparticles and radiate the heat energy at a wavelength of 2 to 20 μm. Therefore, more-efficient heat-retention is achieved because the absorbed energy is exchanged among nanoparticles and radiated with good efficiency.

The amount of nanoparticles of the infrared emissive material that is used in the surface and/or interior of the fiber is preferably between 0.001 wt % to 30 wt % with respect to the solid content of the fiber. If the amount is 0.001 wt % or higher, sufficient heat radiation effect can be obtained even if the cloth is thick. If the added amount is 30 wt % or less, a reduction in the spinnability due to filter clogging, yarn breakage, and other problems can be avoided in the spinning step.

Described next is the preferred particle diameter of the hexaboride nanoparticles and the nanoparticles of the infrared emissive material.

It is generally important that the grain size of inorganic nanoparticles contained in the fiber be such that problems do not occur during spinning, drawing, or other fiber-forming steps. From this standpoint, the average grain size is preferably 5 μm or less, and more preferably 3 μm or less. If the average grain size is 5 μm or less, a reduction in spinnability due to filter clogging, yarn breakage, and other problems can be avoided in the spinning step, and yarn breakage and other problems can be avoided in the drawing step. If the average grain size is 5 μm or less, inorganic nanoparticles can be uniformly mixed and dispersed in the spinning material.

From the standpoint of dyeing characteristics and other design factors of clothing and other fiber materials, there is a need for near-infrared rays to be blocked with good efficiency while transparency is retained. However, when the particle diameter of the fine inorganic grains is considerable, light in the visible region of 400 to 780 nm is scattered by geometrical scattering or diffractive scattering, the material comes to resemble a clouded glass, and clear transparency becomes difficult to obtain. In view of the above, when the diameter of the hexaboride nanoparticles according to the present invention is less than 800 nm, near-infrared rays can be blocked with good efficiency while transparency is retained in the visible region because visible light is not blocked.

Furthermore, the aforementioned scattering is reduced and a Mie or Rayleigh scattering region is formed when the diameter of the inorganic nanoparticles is 200 nm or less. In particular, when the particle diameter is reduced to the Rayleigh scattering region, scattering associated with the reduced particle diameter is reduced and transparency is improved because the scattered light is reduced in reverse proportion to the sixth power of the dispersed particle diameter. When [the particle diameter is] further reduced to 100 nm or less, the scattered light is dramatically reduced, and such a situation is preferred. In view of this fact, the diameter of the inorganic nanoparticles is preferably 200 nm or less, and more preferably 100 nm or less in the particular case that transparency in the visible region is a priority.

An additional preferred configuration in one in which the weather resistance of the hexaboride nanoparticles is improved by coating the surface of the nanoparticles with a compound containing one or more elements selected from silicon, zirconium, titanium, and aluminum. These compounds are essentially transparent, and the design characteristics of a fiber are not compromised because the transmissivity of visible light is not reduced by having coated the hexaboride nanoparticles. Also, these compounds are preferably oxides. These oxides improve the heat-retaining effects because of the high infrared radiation capacity.

The fiber that is used in the present invention can be selected from any type in accordance with the intended application, and any of the following may be used: synthetic fiber, semisynthetic fiber, natural fiber, recycled fiber, inorganic fiber, or a yarn mixture, a doubled yarn, a combined filament yarn, or another yarn in which any of the above are used. Synthetic fiber is preferred from the standpoint of heat retention characteristics and the fact that hexaboride nanoparticles, the nanoparticles of an infrared emissive material, or other inorganic nanoparticles can be added to the fiber using simple methods.

The synthetic fiber is not particularly limited, and examples include polyurethane fiber, polyamide fiber, acrylic fiber, polyester fiber, polyolefin fiber, polyvinyl alcohol fiber, polyvinylidene chloride fiber, polyvinyl chloride fiber, and polyether-ester fiber.

In this case, examples of the polyamide fiber include nylon, nylon 6, nylon 66, nylon 11, nylon 610, nylon 611, aromatic nylon, and aramid.

Examples of the acrylic fiber include polyacrylonitrile, acrylonitrile-vinyl chloride copolymer, and modacrylic.

Examples of the polyester fiber include polyethylene terephthalate, polybutylene terephthalate, polytrimethylene terephthalate, and polyethylene naphthalate.

Examples of the polyolefin fiber include polyethylene, polypropylene, and polystyrene.

An example of the polyvinyl alcohol fiber is vinylon.

An example of the polyvinylidene chloride fiber is vinylidene.

An example of the polyvinyl chloride fiber is polyvinyl chloride.

Examples of the polyether-ester fiber include Rexe and Success.

In the case that the fiber used in the present invention is a semisynthetic fiber, examples of such a fiber include cellulose fiber, protein fiber, chlorinated rubber, and hydrochlorinated rubber.

Examples of the cellulose fiber include acetate, triacetate, and acetate oxide.

In this case, an example of the protein fiber is Promix.

In the case that the fiber used in the present invention is a natural fiber, examples of such a fiber include plant fiber, animal fiber, and mineral fiber.

Examples of the plant fiber include cotton, kapok, flax, hemp, jute, Manila hemp, sisal, New Zealand hemp, dogbane, palm, rush, and straw.

Examples of the animal fiber include silk, down, feathers, sheep wool, goat wool, mohair, cashmere, and wools from alpacas, angoras, camels, and vicugnas.

Examples of the mineral fiber include asbestos and asbestos.

In the case that the fiber used in the present invention is a recycled fiber, examples of such a fiber include cellulose fiber, protein fiber, algin fiber, rubber fiber, chitin fiber, and mannan fiber.

Examples of cellulose fiber include rayon, viscose rayon, cupra, polynosic, and cuprammonium rayon.

Examples of protein fiber include casein fiber, peanut protein fiber, corn protein fiber, soybean protein fiber, and recycled silk thread.

In the case that the fiber used in the present invention is an inorganic fiber, examples of such a fiber include metal fiber, carbon fiber, and silicate fiber.

Examples of metal fiber include metal fiber, gold thread, silver thread, and heat-resistant alloy fiber.

Examples of silicate fiber include fiberglass, slag fiber, and rock fiber.

The cross-sectional shape of the fiber used in the present invention is not particularly limited, and examples of such shapes include circular, triangular, hollow, flat, Y, and star. Nanoparticles can be added to the surface and/or interior of the fiber in a variety of modes, and examples that may be used include adding nanoparticles to the core or sheath of the fiber in the case that core-and-sheath fiber is used. The shape of the fiber used in the present invention may be a filament (long fiber) or a staple (short fiber).

Other preferred configurations are ones in which antioxidants, flame retardants, deodorizers, moth-proofing agents, antibacterial agents, UV absorbers, and the like are added as desired to the fiber used in the present invention in a range that does not compromise performance.

Following is a description of the method for uniformly adding hexaboride nanoparticles, nanoparticles of an infrared emissive material, or other inorganic nanoparticles to the surface and/or interior of the fiber used in the present invention.

The method for uniformly adding inorganic nanoparticles to the surface and/or interior of the fiber is not particularly limited, and the following are examples of such a method.

(1) A method in which the inorganic nanoparticles are directly mixed and spun in the starting polymer material of a synthetic fiber.

(2) A method in which a master batch is manufactured having a high concentration of inorganic nanoparticles added in advance to a portion of the starting polymer material, the master batch is diluted and adjusted to a prescribed concentration at the time of spinning, and the material is thereafter spun.

(3) A method in which the inorganic nanoparticles are uniformly dispersed in advance in a starting monomer material or an oligomer solution, the target starting polymer material is synthesized using the dispersed solution, the inorganic nanoparticles are uniformly dispersed in the starting polymer material at the same time, and the material is thereafter spun.

(4) A method in which inorganic nanoparticles are deposited on the surface of the desired fibers obtained by spinning the material in advance, using a bonding agent or the like.

Following is a more detailed description of a preferred example of the method (2) described above in which a master batch is manufactured, the master batch is diluted and adjusted at the time of spinning, and the material is thereafter spun.

The method of manufacturing a master batch is not particularly limited, and an example of such a method entails removing solvents and uniformly melting and mixing hexaboride nanoparticles, granules or pellets of a thermoplastic resin, and other additives as required in a ribbon blender, tumbler, Nauta mixer, Henschel mixer, super mixer, planetary mixer, or another mixer, and in a Banbury mixer, kneader, roller, kneader ruder, single-screw extruder, twin-screw extruder, or another kneader to obtain a mixture in which the nanoparticles are uniformly dispersed in a thermoplastic resin.

It is also possible to prepare a mixture in which nanoparticles have been uniformly dispersed in a thermoplastic resin using a method whereby the solvent of the hexaboride nanoparticle liquid dispersion has been removed by known methods, and the resulting powder, the granules or pellets of the thermoplastic resin, and other optional additives have been uniformly melted and mixed. Another method that can be used is one in which pulverulent hexaboride nanoparticles are directly added to the thermoplastic resin and uniformly melted and mixed therein.

A master batch containing a heat-absorbing component can be obtained by kneading the mixture obtained by the above-described method using a vent-type single-screw or twin-screw extruder and forming the mixture into pellets.

Following is a description of specific examples of the methods (1) to (4) for uniformly adding inorganic nanoparticles to the fiber used in the present invention as described above.

Methods 1 and 2: In the case that, for example, polyester fiber is used, a hexaboride nanoparticle liquid dispersion is added to polyethylene terephthalate resin pellets, which are a thermoplastic resin; the mixture is uniformly mixed in a blender; the solvent is removed; the mixture is thereafter melted and kneaded using a twin-screw extruder; and a master batch containing hexaboride nanoparticles is prepared. The master batch containing hexaboride nanoparticles, and the target amount of the master batch composed of polyethylene terephthalate without added nanoparticles, are melted and mixed in the vicinity of the melting temperature of the resin, and the material is spun.

Method 3: When, for example, urethane fiber is used, an organic diisocyanate and a polymer diol containing hexaboride nanoparticles are reacted in a twin-screw extruder to synthesize an isocyanate-terminated prepolymer, and the prepolymer is then reacted with a chain extender to fabricate a polyurethane solution (starting polymer material). The material is then spun in accordance with normal methods.

Method 4: In order to deposit inorganic nanoparticles on the surface of a natural fiber, a treatment fluid is prepared by mixing hexaboride nanoparticles, water or another solvent, and at least one binder resin selected from acrylic, epoxy, urethane, and polyester. The natural fiber is immersed [in the treatment fluid] or impregnated with the treatment fluid by padding, printing, spraying, or using another method. The fiber is then dried, whereby hexaboride nanoparticles are deposited on the natural fiber.

Any method may be used for dispersing inorganic nanoparticles such as hexaboride nanoparticles and infrared-emissive material nanoparticles as long as the inorganic nanoparticles are uniformly dispersed in the fluid. Examples of such a method include ultrasonic dispersion methods and methods that use media agitation mills, ball mills, and sand mills. The dispersion medium of the inorganic nanoparticles is not particularly limited and may be selected in accordance with the fiber to be mixed. Examples of the medium include water, alcohol, ether, ester, ketone, aromatic compounds, and other common organic solvents. Also, the medium may be directly mixed with the desired fiber and the polymer, which is the starting material of the fiber. Acid or alkali may be added as required to adjust the pH. Advantageous configurations may also be obtained by adding surfactants, coupling agents, and other additives in order to further improve the dispersion stability of the nanoparticles.

As described in detail above, in accordance with the present invention, hexaboride nanoparticles are used as a heat-absorbing component, and nanoparticles that emit far-infrared rays are jointly used as desired and are added to a fiber, whereby a fiber having excellent heat-retaining properties can be obtained even if only a small amount of inorganic nanoparticles has been added. Since a small amount of inorganic nanoparticles is used, it is possible to avoid compromising the strength, elongation, and other basic physical properties of the fibers. The fiber according to the present invention can be used in cold-weather clothing that requires heat-retaining properties, sports clothing, stockings, curtains, and other fiber materials; in other industrial fiber materials; and in various other applications.

### EXAMPLES

The present invention is described in detail below using examples, but the present invention is not limited by the examples.

### Example 1

200 g of LaB₆ nanoparticles (specific surface area: 30 m²/g) as boride nanoparticles, 730 g of toluene as the dispersion medium, and 70 g of dispersant for dispersing the nanoparticles were mixed together and dispersed in a media agitation mill to prepare 1 kg of LaB₆ nanoparticle dispersion (solution A). The toluene was removed from solution A by using a spray drier to obtain an LaB₆ dispersion powder (powder A).

The resulting powder A was added to polyethylene terephthalate resin pellets, which are a thermoplastic resin, and uniformly mixed in a blender. The mixture was then melted and kneaded using a twin-screw extruder, and the extruded strands were cut into pellet to obtain a master batch containing 30 wt % of LaB₆ nanoparticles, which are the heat-absorbing component.

The master batch of polyethylene terephthalate containing 30 wt % of the LaB₆ nanoparticles was mixed in a 1:1 weight ratio with a similarly prepared master batch of polyethylene terephthalate to which inorganic nanoparticles had not been added. The average grain size of the LaB₆ nanoparticles was measured (by a method hereinafter referred to as the “dark field method”) using a TEM (transmission electron microscope) and found to be 20 nm on the basis of a dark field image formed using a single diffraction ring.

The mixed master batch containing 15 wt % of the LaB₆ nanoparticles was melted, spun, and subsequently drawn to manufacture a polyester multifilament yarn. The resulting multifilament yarn was cut to fabricate polyester staples, and a spun yarn was manufactured using the staples. A knitted product having heat-retaining properties was obtained using the spun yarn.

The spectral characteristics of the fabricated knitted product were measured based on the transmissivity of light having a wavelength of 200 to 2,100 nm by using a spectrophotometer manufactured by Hitachi Ltd, and the sunlight absorption ratio was calculated according to JIS A 5759. (In this case, the sunlight absorption ratio of each of the samples was 8%, and was calculated using the equation: Sunlight absorption ratio (%)=100%−Sunlight transmissivity (%)−Sunlight reflectivity (%).) The sunlight absorption ratio was calculated to be 40.45%.

Next, the temperature-increasing effect on the reverse side of the cloth of the fabricated knitted product was measured in the following manner.

The light of a spectral lamp (Solar Simulator XL-03E50 manufactured by Seric) that approximated the light of the sun was directed to the cloth from a distance of 30 cm in an 20° C./60% RH environment, and the temperature on the reverse side of the cloth was measured using a radiation thermometer (HT-11 manufactured by Minolta) at fixed time intervals (0 seconds, 30 seconds, 60 seconds, 180 seconds, and 360 seconds). The table in FIG. 1 shows the results of measuring the temperature on the reverse side of the cloth of a knitted product at each irradiation time interval of the sunlight-approximated light. FIG. 1 also shows the effect of increasing the temperature on the reverse side of the cloth of the knitted product obtained in examples 2 to 7 and comparative example 1.

### Example 2

A master batch composed of polyethylene terephthalate containing 10 wt % of LaB₆ and Zro₂ nanoparticles in a ratio of 1:1.5 was prepared using the same method as in example 1. The average grain size of the LaB₆ and Zro₂ nanoparticles was measured using a TEM and found to be 20 nm and 30 nm, respectively, by the dark field method.

A multifilament yarn was manufactured by the same method as in example 1 using the master batch containing the two types of nanoparticles. The resulting multifilament yarn was cut to fabricate polyester staples, and a spun yarn was manufactured in the same manner as in example 1. The spun yarn was used to obtain a knitted product.

The spectral characteristics of the fabricated knitted product were measured in the same manner as in example 1. The sunlight absorption ratio was 43.38%. The effect of increasing the temperature on the reverse side of the cloth was measured in the same manner as in example 1. The results are shown in FIG. 1.

### Example 3

A master batch composed of polyethylene terephthalate containing 30 wt % of CeB₆ and Zro₂ nanoparticles in a ratio of 1:1.5 was manufactured using the same method as in example 1. The average grain size of the CeB₆ and Zro₂ nanoparticles was observed using a TEM and found to be 25 nm and 30 nm, respectively, by the dark field method.

A multifilament yarn was manufactured by the same method as in example 1 using the master batch containing the two types of nanoparticles. The resulting multifilament yarn was cut to fabricate polyester staples, and a spun yarn was manufactured in the same manner as in example 1. The spun yarn was used to obtain a knitted product.

The spectral characteristics of the fabricated knitted product were measured in the same manner as in example 1. The sunlight absorption ratio was 39.21%. The effect of increasing the temperature on the reverse side of the cloth was measured in the same manner as in example 1. The results are shown in FIG. 1.

### Example 4

A master batch composed of polyethylene terephthalate containing 30 wt % of PrB₆ and Zro₂ nanoparticles in a ratio of 1:1.5 was manufactured using the same method as in example 1. The average grain size of the PrB₆ and Zro₂ nanoparticles was observed using a TEM and found to be 25 nm and 30 nm, respectively, by the dark field method.

A multifilament yarn was manufactured by the same method as in example 1 using the master batch containing the two types of nanoparticles. The resulting multifilament yarn was cut to fabricate polyester staples, and a spun yarn was manufactured in the same manner as in example 1. The spun yarn was used to obtain a knitted product.

The spectral characteristics of the fabricated knitted product were measured in the same manner as in example 1. The sunlight absorption ratio was 32.95%. The effect of increasing the temperature on the reverse side of the cloth was measured in the same manner as in example 1. The results are shown in FIG. 1.

### Comparative Example 1

A multifilament yarn was manufactured in the same manner as in example 1 using the master batch composed of polyethylene terephthalate described in example 1, but without the addition of inorganic nanoparticles. The resulting multifilament yarn was cut to fabricate polyester staples, and a spun yarn was manufactured in the same manner as in example 1. The spun yarn was used to obtain a knitted product.

The spectral characteristics of the fabricated knitted product were measured in the same manner as in example 1. The sunlight absorption ratio was 3.74%. The effect of increasing the temperature on the reverse side of the cloth was measured in the same manner as in example 1. The results are shown in FIG. 1.

### Example 5

Other than using nylon resin pellets as the thermoplastic resin, a master batch composed of nylon 6 containing 10 wt % of LaB₆ and Zro₂ nanoparticles in a ratio of 1:3 was prepared using the same method as in example 1, and mixed in a 1:1 weight ratio with a similarly prepared master batch of nylon 6 to which inorganic nanoparticles had not been added. The average grain size of the LaB₆ and Zro₂ nanoparticles was observed using a TEM and found to be 20 nm and 30 nm, respectively, by the dark field method.

The mixed master batch containing 5 wt % of LaB₆ and ZrO₂ nanoparticles was melted, spun, and drawn to manufacture a nylon multifilament yarn. The resulting multifilament yarn was cut to fabricate nylon staples, and a spun yarn was manufactured using the staples. The spun yarn was used to obtain a nylon textile product having heat-retaining properties.

The spectral characteristics of the fabricated nylon product were measured in the same manner as in example 1. The sunlight absorption ratio was 44.01%. The effect of increasing the temperature on the reverse side of the cloth was measured in the same manner as in example 1. The results are shown in FIG. 1.

### Example 6

Other than using acrylic resin pellets as the thermoplastic resin, a master batch composed of polyacrylonitrile containing 20 wt % of LaB₆ and Zro₂ nanoparticles in a ratio of 1:3 was prepared using the same method as in example 1, and mixed in a 1:1 weight ratio with a similarly prepared master batch of polyacrylonitrile to which inorganic nanoparticles had not been added. The average grain size of the LaB₆ and Zro₂ nanoparticles was observed using a TEM and found to be 20 nm and 30 nm, respectively, by the dark field method.

The mixed master batch containing 10 wt % of LaB₆ and ZrO₂ nanoparticles was melted, spun, and drawn to manufacture an acrylic multifilament yarn. The resulting multifilament yarn was cut to fabricate acrylic staples, and a spun yarn was manufactured using the staples. The spun yarn was used to obtain an acrylic textile product having heat-retaining properties.

The spectral characteristics of the fabricated acrylic textile product were measured in the same manner as in example 1. The sunlight absorption ratio was 42.57%. The effect of increasing the temperature on the reverse side of the cloth was measured in the same manner as in example 1. The results are shown in FIG. 1.

### Example 7

Polytetramethylene ether glycol (PTG2000) containing 10 wt % of LaB₆ and Zro₂ nanoparticles in a ratio of 1:1.5, and 4,4-diphenylmethane diisocyanate were reacted to prepare an isocyanate-terminated prepolymer. Next, 1,4-butanediol and 3-methyl-1,5-pentanediol were reacted as a chain extender and polymerized with the prepolymer to manufacture a thermoplastic polyurethane solution. The average grain size of the LaB₆ and Zro₂ nanoparticles was observed using a TEM and found to be 20 nm and 30 nm, respectively, by the dark field method.

The resulting polyurethane solution was spun as a stock solution for spinning and drawn to obtain an elastic polyurethane fiber. The fiber was used to obtain a urethane textile product having heat-retaining properties.

The spectral characteristics of the fabricated urethane product were measured in the same manner as in example 1. The sunlight absorption ratio was 43.02%. The effect of increasing the temperature on the reverse side of the cloth was measured in the same manner as in example 1. The results are shown in FIG. 1.

### EVALUATION

It is apparent from a comparison of examples 1 to 7 and comparative example 1 that the temperature on the reverse side of the cloth fabricated from the fibers [in the examples] is on average 14° C. higher than in the comparative example after 30 seconds have elapsed, and that excellent heat-retaining properties are imparted by adding hexaboride nanoparticles and ZrO₂ nanoparticles to the fibers.

Based on the above, hexaboride nanoparticles and an optional infrared-emissive material are added to the fiber. The resulting fiber has excellent transparency, good weather resistance, and low cost. Heat rays from the sun or other light sources are absorbed with good efficiency by the fiber. Also, a textile product can be obtained from the fiber. The design characteristics of the product are not compromised, and excellent heat-retaining properties are provided at the same time.

Based on their excellent characteristics, the fibers and textile products obtained using these fibers can be used in cold-weather clothing, sports clothing, stockings, curtains, and other fiber materials that require heat-retaining properties; in other industrial fiber materials; and in various other applications.

### INDUSTRIAL APPLICABILITY

As described above, the present invention is a boride nanoparticle-containing fiber comprising boride nanoparticles expressed by the general formula XBₘ (wherein X is at least one or more elements selected from La, Ce, Pr, Nd, Sm, Eu, Gd, Tb, Dy, Ho, Er, Tm, Yb, Lu, Sr, Ca, and Y) as a heat-absorbing component, wherein the surface and/or the interior of the fiber contains 0.001 wt % to 30 wt % of the nanoparticles with respect to the solid content of the fiber. It is thereby possible to obtain a hexaboride nanoparticle-containing fiber that has good transparency and absorbs heat rays with good efficiency.

### BRIEF DESCRIPTION OF THE DRAWINGS

FIG. 1 is a table of the temperature measurement results on the reverse side of a knitted cloth product for each irradiation time interval of light that approximates sunlight.

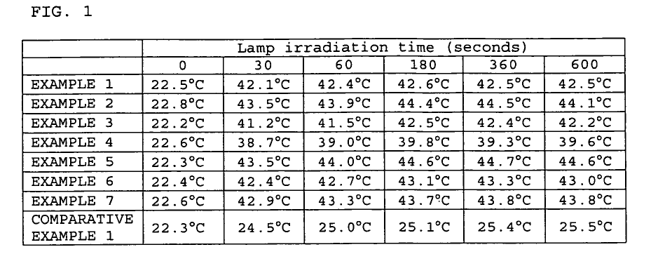

What is claimed is:

1. A clothing requiring heat-retaining properties and formed by processing a fiber comprising boride nanoparticles expressed by the general formula XBₘ (wherein X is at least one or more elements selected from La, Ce, Pr, Nd, Sm, Eu, Gd, Tb, Dy, Ho, Er, Tm, Yb, Lu, Sr, Ca, and Y; and 4<=m<6.3) as a heat-absorbing component, and ZrO₂ nanoparticles as a far-infrared emissive material wherein
a surface and/or an interior of the fiber contains 0.001 wt % to 30 wt % of the boride nanoparticles and 0.001 wt % to 30 wt % of the ZrO₂ nanoparticles with respect to the solid content of the fiber.

2. The clothing according to claim 1, wherein the particle diameter of the boride nanoparticles is 800 nm or less.

3. The clothing according to claim 1, wherein a surface of the boride nanoparticles is covered with a compound containing at least one or more elements selected from silicon, zirconium, titanium, and aluminum.

4. The clothing according to claim 3, wherein the compound is an oxide.

5. The clothing according to claim 1, wherein the fiber is a synthetic fiber, a semisynthetic fiber, a natural fiber, a recycled fiber, an inorganic fiber, or a yarn mixture composed of a blend, a doubled yarn, a combined filament yarn, or another combination of the fibers.

6. The clothing according to claim 5, wherein the synthetic fiber is a synthetic fiber composed of one or more fibers selected from polyurethane fiber, polyamide fiber, acrylic fiber, polyester fiber, polyolefin fiber, polyvinyl alcohol fiber, polyvinylidene chloride fiber, polyvinyl chloride fiber, and polyether-ester fiber.

7. The clothing according to claim 5, wherein the semisynthetic fiber is a semisynthetic fiber composed of one or more fibers selected from cellulose fiber, protein fiber, chlorinated rubber, and hydrochlorinated rubber.

8. The clothing according to claim 5, wherein the natural fiber is a natural fiber composed of one or more fibers selected from plant fiber, animal fiber, and mineral fiber.

9. The clothing according to claim 5, wherein the recycled fiber is a recycled fiber composed of one or more fibers selected from cellulose fiber, protein fiber, algin fiber, rubber fiber, chitin fiber, and mannan fiber.

10. The clothing according to claim 5, wherein the inorganic fiber is an inorganic fiber composed of one or more fibers selected from metal fiber, carbon fiber, and silicate fiber.

11. A boride nanoparticle-containing fiber constituting the clothing according to claim 1, wherein
the fiber comprises boride nanoparticles expressed by the general formula XBₘ (wherein X is at least one or more elements selected from La, Ce, Pr, Nd, Sm, Eu, Gd, Tb, Dy, Ho, Er, Tm, Yb, Lu, Sr, Ca, and Y; and 4<=m<6.3) as a heat-absorbing component, and ZrO₂ nanoparticles as a far-infrared emissive material, and
the surface and/or the interior of the fiber contains 0.001 wt % to 30 wt % of the boride nanoparticles and 0.001 wt % to 30 wt % of the ZrO₂ nanoparticles with respect to the solid content of the fiber.

12. The boride nanoparticle-containing fiber according to claim 11, wherein the particle diameter of the boride nanoparticles is 800 nm or less.
